(19) United States
(12) Patent Application Publication
(10) Pub. No.: US 2026/0179317 A1
(43) Pub. Date: Jun. 25, 2026

(54) 3D SPARSE RECONSTRUCTION METHOD AND DEVICE FOR MONOCULAR IMAGE OF NON-METALLIC PIPELINE FOR DEEP-SEA MINING

(71) Applicant: CHINA UNIVERSITY OF PETROLEUM, Beijing (CN)

(72) Inventors: Yingying WANG, Beijing (CN); Chong CHEN, Beijing (CN); Gang LIU, Beijing (CN); Yufang LI, Beijing (CN); Chuanbo CONG, Beijing (CN); Haibo SUN, Beijing (CN); Wenhua WANG, Beijing (CN); Ke WANG, Beijing (CN); Zongyu HAN, Beijing (CN); Zeqing LIN, Beijing (CN); Kai ZHANG, Beijing (CN)

(73) Assignee: CHINA UNIVERSITY OF PETROLEUM, Beijing (CN)

(21) Appl. No.: 19/373,904

(22) Filed: Oct. 30, 2025

(30) Foreign Application Priority Data
Dec. 20, 2024 (CN) 202411894235.X

(51) Int. Cl. G06T 17/00; B25J 9/16; G06T 7/80; G06V 10/77; G06V 10/80

(52) U.S. Cl. CPC G06T 17/00; B25J 9/1664; B25J 9/1697; G06T 7/80; G06V 10/7715; G06V 10/806

(57) ABSTRACT

The present disclosure relates to a 3D sparse reconstruction method and device for a monocular image of a non-metallic pipeline for deep-sea mining. The 3D sparse reconstruction method includes the following steps: acquiring internal pictures of a to-be-detected non-metallic pipeline by using a robot carrying a monocular camera to form a dataset; performing feature point detection and matching on the dataset by using a deep-learning-based feature point matching network model; aggregating and redistributing obtained feature points; and based on the aggregated feature points, performing 3D sparse reconstruction by using an improved incremental reconstruction algorithm to obtain internal structural information of the to-be-detected non-metallic pipeline. The present disclosure can be widely applied in the technical field of non-metallic pipeline detection.

### CROSS-REFERENCE TO RELATED APPLICATION

The present claims priority to CN 202411894235.X filed Dec. 20, 2024, the content of which is incorporated by reference in its entirety.

### TECHNICAL FIELD

The present disclosure relates to a 3D sparse reconstruction method and device for a monocular image of a non-metallic pipeline for deep-sea mining, and belongs to the technical field of non-metallic pipeline detection.

### BACKGROUND

A flexible non-metallic multiphase transportation pipeline, as the “main artery” of a deep-sea mining system, is the most critical transportation equipment in a hydraulic hose lifting mining system. It not only can effectively prevent the problem that metal pipelines are prone to corrosion in deep-sea environments, but also has advantages such as installation simplicity, low maintenance cost, and long service life. Although non-metallic pipelines have various advantages, some problems are gradually exposed during use, such as leakage, damage and other failure phenomena. Therefore, it is essential to perform continuous condition monitoring and performance evaluation on these non-metallic pipelines for long-term service.

In recent years, with the rapid development of a computer vision technology, researchers have increasingly used a 3D reconstruction technology for pipeline modeling and detection. By using this method, a complete pipeline model can be reconstructed by only capturing an image of an inner wall of a pipeline through a visual device, so that the problems such as high cost and poor universality and flexibility of special-purpose sensors in traditional non-destructive testing technologies are overcome, and a new approach is provided for pipeline defect evaluation. According to the number of cameras, the 3D reconstruction technology can be divided into three types: monocular reconstruction, binocular reconstruction, and multi-view reconstruction. The monocular reconstruction means that one camera is used to capture a plurality of pictures to construct a 3D model, a relationship between a feature and a spatial structure is established by analyzing feature changes in an image sequence, and a 3D form of an object is reconstructed. Compared with the binocular or multi-view reconstruction, the monocular reconstruction has a more complex reconstruction process although it is lower in cost.

The current research mainly focuses on the reconstruction of metal pipelines. Due to the characteristic of common lack of textures on deep-sea non-metallic pipelines and the location in no-light or low-light environments, the details of video images captured by monocular cameras are blurred. Therefore, a technology for reconstructing an inner surface of a non-metallic pipeline by using a monocular cameras has not been widely researched. The present technology has poor effects, and even cannot achieve reconstruction when applied to deep-sea non-metallic pipelines.

### SUMMARY

For solving the above-mentioned problems, the object of the present disclosure is to provide a 3D sparse reconstruction method and device for a monocular image of a non-metallic pipeline for deep-sea mining, which can achieve 3D sparse reconstruction of a deep-sea non-metallic pipeline and intuitively show internal structural information of the pipeline.

In order to achieve the above-mentioned object, the present disclosure adopts the following technical solutions:
in a first aspect, the present disclosure provides a 3D sparse reconstruction method for a monocular image of a non-metallic pipeline for deep-sea mining, including the following steps:
acquiring internal pictures of a to-be-detected non-metallic pipeline by using a robot carrying a monocular camera to form a dataset;
performing feature point detection and matching on the dataset by using a deep-learning-based feature point matching network model;
aggregating and redistributing obtained feature points; and
based on the aggregated feature points, performing 3D sparse reconstruction by using an improved incremental reconstruction algorithm to obtain internal structural information of the to-be-detected non-metallic pipeline.

Further, the acquiring internal pictures of a to-be-detected non-metallic pipeline by using a robot carrying a monocular camera to form a dataset includes:
determining a structure of the robot;
wherein the robot includes a camera protective cover, a camera compartment, a plurality of odometer wheels, a substrate, and support wheels; a lower part of the substrate is fixedly connected with a bottom plate through a flange, and three support wheels playing a supporting role are disposed on a lower part of the bottom plate to ensure that a center line of the robot and a center line of the pipeline are located on the same line; an upper part of the substrate is connected with the camera compartment through another flange, and a spring is provided between the camera compartment and another flange; the camera protective cover is disposed on the top of the camera compartment to protect the monocular camera placed inside the camera compartment; the odometer wheels are spaced outside the camera compartment, and magnetic encoders are built in the odometer wheels to measure angles of rotation of the odometer wheels; and a circuit system is placed inside the substrate to receive pulse signals sent by the magnetic encoders, calculate displacement data of the robot according to parameters of the odometer wheels, and control the monocular camera to take the internal pictures of the pipeline according to the displacement data;
carrying the monocular camera by the robot, and calibrating the monocular camera by using a Zhang's calibration method to acquire intrinsic parameters of the camera; and
placing the robot into the to-be-detected non-metallic pipeline, controlling the robot to move forwards at a preset speed, and meanwhile, taking the internal pictures of the to-be-detected non-metallic pipeline by using the monocular camera to form the dataset.

Further, the carrying the monocular camera by the robot, and calibrating the monocular camera by using a Zhang's calibration method to acquire intrinsic parameters of the camera includes:
fixing a preset black-and-white checkerboard calibration paper on a desktop;
capturing a plurality of images of the calibration paper at different angles and positions by using the monocular camera carried by the robot, and ensuring that a checkerboard pattern in each image is within a field of view, wherein during capturing, a posture and position of the monocular camera should be sufficiently varied to cover different viewing angles; and
based on image information obtained from the calibration paper, calculating the intrinsic parameters of the monocular camera by using the Zhang's calibration method.

Further, the placing the robot into the to-be-detected non-metallic pipeline, controlling the robot to move forwards at a preset speed, and meanwhile, taking the internal pictures of the to-be-detected non-metallic pipeline by using the monocular camera to form the dataset includes:
placing the robot carrying the monocular camera at an inlet of the to-be-detected non-metallic pipeline, and clearing data of the odometer wheels;
controlling the robot to move forwards in the to-be-detected non-metallic pipeline, meanwhile, acquiring displacement information of the robot in the to-be-detected non-metallic pipeline by the circuit system inside the substrate through the odometer wheels, controlling the monocular camera to take the internal pictures of the to-be-detected non-metallic pipeline according to the displacement information, and saving the pictures; and
stopping the robot after reaching an endpoint, reading all the pictures by using an upper computer, and creating the dataset of the internal pictures of the to-be-detected non-metallic pipeline in a picture taking order.

Further, the performing feature point detection and matching on the dataset by using a deep-learning-based feature point matching network model includes:
performing different-scale feature extraction on input pictures by using a feature pyramid network to obtain a ½-scale feature map and a ⅛-scale feature map;
based on the ⅛-scale feature map, performing processing by using a coarse-grained matching model to obtain a rough matching region; and
based on the ½-scale feature map and the rough matching region, performing processing by using a fine-grained matching model to obtain accurate positions of matched feature points.

Further, the performing different-scale feature extraction on input pictures by using a feature pyramid network to obtain a ½-scale feature map and a ⅛-scale feature map includes:
performing feature extraction on two input images to sequentially obtain ½-scale and ¼-scale downsampled feature maps, and outputting the ⅛-scale feature map;
upsampling the different-scale downsampled feature maps obtained at a feature extraction stage by using bilinear interpolation to sequentially obtain ¼-scale and ½-scale upsampled feature maps; and
fusing the ½-scale upsampled feature map with the ½-scale downsampled feature map to obtain the final ½-scale feature map.

Further, the based on the ⅛-scale feature map, performing processing by using a coarse-grained matching model to obtain a rough matching region includes the following steps:
performing dimensional transformation on coarse-level features of two images at ⅛ scale to obtain a score matrix S;
respectively applying a softmax operator to two dimensions of the score matrix, and transforming the score matrix into a probability to obtain a confidence matrix P_{c}; and
based on the confidence matrix P_{c}, filtering out matching with confidence being lower than a threshold θ_{c}, and performing a mutual nearest neighbor criterion on remaining matching to obtain the rough matching region (\tilde{τ}, \tilde{j}).

Further, the based on the ½-scale feature map and the rough matching region, performing processing by using a fine-grained matching model to obtain accurate positions of matched feature points includes the following steps:
positioning rough matching (\tilde{ι}, \tilde{J}) in fine-level feature maps \hat{F}^{A} and \hat{F}^{B} to obtain a local neighborhood (\hat{ι}, Ĵ);
cropping two sets of local features

$${\hat{F}}_{c}^{A} and {\hat{F}}_{c}^{B}$$

with a size of w×w, and performing Feature-Transformer transformation on the local neighborhood (\hat{ι},Ĵ) to obtain two local feature maps

$${\hat{F}}_{tr}^{A} and {\hat{F}}_{tr}^{B} ;$$

obtaining a heat map of a matching probability of the two feature maps by using similarity calculation and a softmax function; and
calculating the accurate positions of the matched points from the heat map by using a DSNT algorithm.

Further, the performing 3D sparse reconstruction by using an improved incremental reconstruction algorithm to obtain internal structural information of the to-be-detected non-metallic pipeline includes the following steps:
\textcircled{1} selecting two pictures, obtaining an initial camera pose by using a PnP algorithm, triangulating the images according to the initial camera pose to obtain 3D points as an initial point cloud model, and using local BA optimization;
\textcircled{2} selecting an image with the most matched points in the point cloud model, obtaining a camera pose of a new image by using the PnP algorithm, and triangulating the new image according to the camera pose to obtain new 3D points;
\textcircled{3} using an improved RANSAC algorithm to detect whether the point cloud model is cylindrical, and if the point cloud model is detected to be cylindrical, adding cylinder constraints to local RA to optimize positions of the 3D points; and
\textcircled{4} repeating steps \textcircled{2} to \textcircled{3} until the feature points of all the images are added to the point cloud model.

In a second aspect, the present disclosure provides a 3D sparse reconstruction device for a monocular image of a non-metallic pipeline for deep-sea mining, including:
a data acquisition module configured to acquire internal pictures of a to-be-detected non-metallic pipeline by using a robot carrying a monocular camera to form a dataset;
a feature point matching module configured to perform feature point detection and matching on the dataset by using a deep-learning-based feature point matching network model;
an aggregation and redistribution module configured to aggregate and redistribute obtained feature points; and
a 3D coefficient reconstruction module configured to perform 3D sparse reconstruction by using an improved incremental reconstruction algorithm to obtain internal structural information of the to-be-detected non-metallic pipeline.

Due to the adoption of the above technical solutions, the present disclosure has the following advantages:

1. In the present disclosure, firstly, the feature points of the non-metallic pipeline are extracted and matched by using the deep-learning-based feature point matching model. Then, a 3D sparse point cloud is generated by using an improved incremental reconstruction technology so as to accurately show a geometric shape and structural information of a deep-sea flexible non-metallic pipeline. The present disclosure is beneficial to monitoring the deformation, damage, and wear of flexible pipes in complex deep-sea environments, thereby providing timely warning and maintenance to prevent pipeline failure. By means of the 3D reconstruction of the flexible non-metallic pipe, environmental pollution or mining accidents caused by pipeline damage or design defects can be effectively avoided, and thus, the safety of deep-sea mining is improved.

2. The robot in the present disclosure only needs to carry a monocular camera, and the subsequent reconstruction process is mainly implemented by algorithms, without the need for an expensive special-purpose sensor.

3. In the present disclosure, the deep-learning-based feature point matching model is designed, and this model proposes a deep-learning-based feature point extraction and matching network with reference to a human behavior mode, and includes two matching stages from coarse to fine and a reparametrized network design that expands a receptive field, thereby solving the problem of difficulty in feature matching of textureless pictures.

4. The present disclosure proposes the improved incremental reconstruction algorithm, which can reduce the radius error rate and the distortion of 3D points by improving the RANSAC algorithm and adding circular constraints for BA optimization.

The present disclosure can be widely applied in the technical field of non-metallic pipeline detection, and even the technical field of deep-sea mining.

### BRIEF DESCRIPTION OF THE DRAWINGS

By reading the detailed description for the following preferred embodiments, various other advantages and benefits will become clear to those of ordinary skill in the art. The accompanying drawings are only for the purpose of illustrating the preferred embodiments, and are not to be considered as limitations on the present disclosure. In the entire accompanying drawings, the same reference numerals are used to indicate the same components. In the accompanying drawings:

FIG. 1 is a flow diagram of a 3D sparse reconstruction method for a monocular image of a non-metallic pipeline for deep-sea mining provided in an embodiment of the present disclosure;

FIG. 2 is a structural diagram of a robot provided in an embodiment of the present disclosure;

FIG. 3 is a flow diagram of a deep-learning-based feature point matching model provided in an embodiment of the present disclosure;

FIG. 4 is a flow diagram of a feature pyramid network provided in an embodiment of the present disclosure;

FIG. 5 is a structural diagram of an encoder of a Feature Transformer module provided in an embodiment of the present disclosure;

FIG. 6 is a flow diagram of an improved incremental reconstruction algorithm provided in an embodiment of the present disclosure;

FIG. 7 is a flow diagram of an improved RANSAC algorithm provided in an embodiment of the present disclosure;

FIG. 8 is an effect diagram of cone point defect reconstruction provided in an embodiment of the present disclosure;

FIG. 9 is an effect diagram of groove defect reconstruction provided in an embodiment of the present disclosure; and

FIG. 10 is an effect diagram of strip defect reconstruction provided in an embodiment of the present disclosure.

The reference numerals in the accompanying drawings are shown as follows:

1. Camera protective cover; 2. Camera compartment; 3. Odometer wheel; 4. Substrate; and 5. Support wheel.

### DETAILED DESCRIPTION

In order to clarify the objects, technical solutions and advantages of embodiments of the present disclosure, the technical solutions of the embodiments of the present disclosure will be described clearly and completely below in conjunction with the accompanying drawings of the embodiments of the present disclosure. Obviously, the described embodiments are a part of the embodiments of the present disclosure, not all the embodiments. Based on the described embodiments of the present disclosure, all other embodiments obtained by those of ordinary skill in the art shall fall within the protective scope of the present disclosure.

It should be noted that terms used herein are only intended to describe specific embodiments, rather than to limit exemplary embodiments according to the present disclosure. As used herein, unless otherwise explicitly stated in the context, a singular form is also intended to include a plural form. In addition, it should be further understood that when terms “including” and/or “include” are used in this description, it is indicated that there are features, steps, operations, devices, components, and/or combinations thereof.

In some embodiments of the present disclosure, provided is a 3D sparse reconstruction method for a monocular image of a non-metallic pipeline for deep-sea mining, by which the problem of difficulty in feature matching of textureless pictures is solved by using a deep-learning-based feature point extraction and matching network model; and meanwhile, an RANSAC algorithm and a BA algorithm in an incremental reconstruction method are improved, so that 3D sparse reconstruction of a deep-sea flexible non-metallic pipe can be effectively achieved, and internal structural information of a pipeline can be intuitively shown.

Correspondingly, in other embodiments of the present disclosure, provided is a 3D sparse reconstruction device for a monocular image of a non-metallic pipeline for deep-sea mining.

### Embodiment 1

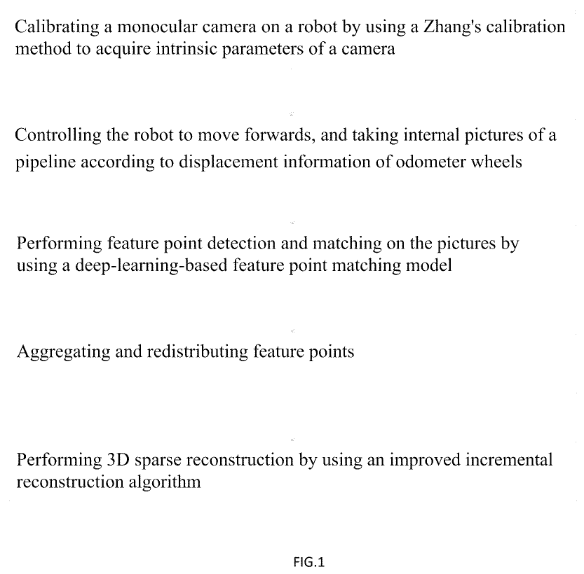

As shown in FIG. 1, this embodiment provides a 3D sparse reconstruction method for a monocular image of a non-metallic pipeline for deep-sea mining, including the following steps:
S1, internal pictures of a to-be-detected non-metallic pipeline are acquired by using a robot carrying a monocular camera to form a dataset;
S2, feature point detection and matching are performed on the dataset by using a deep-learning-based feature point matching network model;
S3, obtained feature points are aggregated and redistributed; and
S4, based on the aggregated feature points, 3D sparse reconstruction is performed by using an improved incremental reconstruction algorithm to obtain internal structural information of the to-be-detected non-metallic pipeline.

Further, the above-mentioned step S1 that internal pictures of a to-be-detected non-metallic pipeline are acquired by using a robot carrying a monocular camera to form a dataset includes the following steps:
S1.1, a structure of the robot is determined;
S1.2, the monocular camera is carried by the robot, and the monocular camera is calibrated by using a Zhang's calibration method to obtain intrinsic parameters of the camera;
S1.3, the robot is placed into the to-be-detected non-metallic pipeline, the robot is controlled to move forwards at a preset speed, and meanwhile, the internal pictures of the to-be-detected non-metallic pipeline are taken by using the monocular camera to form the dataset.

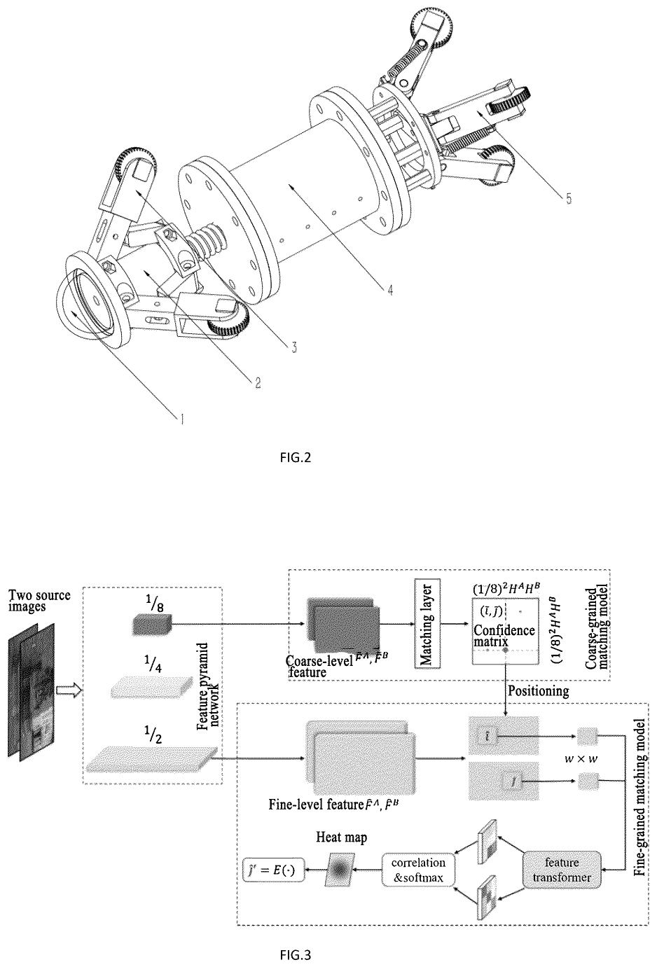

Further, in the above-mentioned step S1.1, as shown in FIG. 2, the robot adopted in this embodiment includes: a camera protective cover 1, a camera compartment 2, odometer wheels 3, a substrate 4, and support wheels 5. Wherein a lower part of the substrate 4 is fixedly connected with a bottom plate through a flange, and three support wheels 5 playing a supporting role are disposed on a lower part of the bottom plate to ensure that a center line of the robot and a center line of the pipeline are located on the same line; an upper part of the substrate 4 is connected with the camera compartment 2 through another flange, and a spring is provided between the camera compartment 2 and the flange; the camera protective cover 1 is disposed on the top of the camera compartment 2 to protect the monocular camera placed inside the camera compartment 2; the odometer wheels 3 are disposed outside the camera compartment 2, and magnetic encoders are built in the odometer wheels to measure angles of rotation of the odometer wheels 3; and a circuit system with stm32f4 as a core is placed inside the substrate 4 to receive pulse signals sent by the magnetic encoders, calculate displacement data of the robot according to parameters of the odometer wheels, and then control the monocular camera to take the internal pictures of the pipeline according to the displacement data.

Further, the above-mentioned step S1.2 that the monocular camera is calibrated by using a Zhang's calibration method to obtain intrinsic parameters of the camera includes the following steps:
S1.2.1, a preset black-and-white checkerboard calibration paper is fixed on a desktop;
S1.2.2, a plurality of images of the calibration paper are captured at different angles and positions by using the monocular camera carried by the robot, and it is ensured that a checkerboard pattern in each image is within a field of view, wherein during capturing, a posture and position of the monocular camera should be sufficiently varied to cover different viewing angles; and
S1.2.3, based on image information obtained from the calibration paper, the intrinsic parameters of the monocular camera are calculated by using the Zhang's calibration method.

In this embodiment, the intrinsic parameters of the monocular camera include an intrinsic parameter matrix M₁ and a distortion coefficient β which are respectively represented as:

$${M}_{1} = [ \begin{matrix}{f}_{x} & 0 & {c}_{x} \\ 0 & {f}_{y} & {c}_{y} \\ 0 & 0 & 1\end{matrix} ] \qquad ( 1 )$$

$$β = ( {k}_{1} , {k}_{2} , {k}_{3} , {p}_{1} , {p}_{2} ) \qquad ( 2 )$$

in the equation, fₓ and f_{y} are respectively focal lengths in the x direction and the y direction, cₓ and c_{y} are principal point coordinates of the camera, (k₁, k₂, k₃) is a radial distortion coefficient, and (p₁, p₂) is a tangential distortion coefficient.

These parameters are essential basic information in a subsequent 3D reconstruction process, ensure the accuracy of a 3D reconstruction result, and finally achieve high-quality 3D reconstruction.

Further, the above-mentioned step S1.3 that the robot is placed into the to-be-detected non-metallic pipeline, the robot is controlled to move forwards at a preset speed, and meanwhile, the internal pictures of the to-be-detected non-metallic pipeline are taken by using the monocular camera to form the dataset includes the following steps:
S1.3.1, the robot carrying the monocular camera is placed at an inlet of the to-be-detected non-metallic pipeline, and data of the odometer wheels 3 is cleared;
S1.3.2, the robot is controlled to move forwards in the to-be-detected non-metallic pipeline, meanwhile, displacement information of the robot in the to-be-detected non-metallic pipeline is acquired by the circuit system inside the substrate 4 through the odometer wheels 3, the monocular camera is controlled to take the internal pictures of the to-be-detected non-metallic pipeline according to the displacement information, and the pictures are saved; and
S1.3.3, the robot is stopped after reaching an endpoint, all the pictures are read by using an upper computer, and the dataset of the internal pictures of the to-be-detected non-metallic pipeline is created in a picture taking order.

Further, in the above-mentioned step S2, feature matching methods can be divided into two types: a feature-detector-based feature matching method and a detector-free feature matching method. The feature point matching network model designed in the present disclosure is the detector-free method which does not rely on the detection of the feature points. With reference to a strategy adopted by the human brain in similar pattern matching, the present disclosure proposes a progressive matching mode from coarse to fine, in which feature vectors are generated for all regions of the images at coarse granularity by using a large-kernel convolutional neural network with a reparameterization characteristic, and all possible matching situations of the two images are traversed. After further refinement, matched point pairs are directly generated, and the refined positions are used as the positions of the feature points.

As shown in FIG. 3, the deep-learning-based feature point matching network model constructed in this embodiment specifically includes three parts: a feature pyramid network, a coarse-grained matching model, and a fine-grained matching model. Specifically, included are the following steps:
S2.1, different-scale feature extraction is performed on input pictures by using a feature pyramid network to obtain a ½-scale feature map, a ¼-scale feature map and a ⅛-scale feature map, wherein the ¼-scale feature map serves as an intermediate variable;
S2.2, based on the ⅛-scale feature map, processing is performed by using a coarse-grained matching model to obtain a rough matching region; and
S2.3, based on the ½-scale feature map and the rough matching region, processing is performed by using a fine-grained matching model to obtain accurate positions of matched feature points.

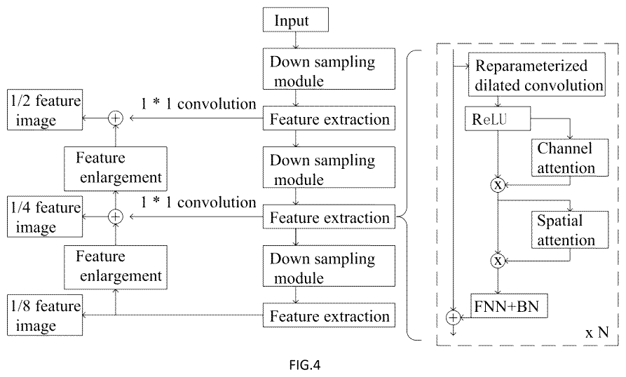

Further, in the above-mentioned step S2.1, as shown in FIG. 4, when the different-scale feature extraction is performed on the input pictures by using the feature pyramid network, the different-scale feature extraction is mainly divided into three stages: a feature extraction stage, a feature enlargement stage, and a horizontally-connected feature fusion stage. This structure aims to achieve effective extraction, enlargement and integration of image features so as to achieve a task of matching the textureless images.

Specifically, included are the following steps:
S2.1.1, feature extraction is performed on two input images to sequentially obtain ½-scale and ¼-scale downsampled feature maps, and the ⅛-scale feature map is outputted, wherein the downsampled feature maps are further used in subsequent steps;
S2.1.2, the different-scale downsampled feature maps obtained at a feature extraction stage are upsampled by using bilinear interpolation to sequentially obtain ¼-scale and ½-scale upsampled feature maps; and
S2.1.3, the ½-scale upsampled feature map is fused with the ½-scale downsampled feature map to obtain the final ½-scale feature map.

Further, in the above-mentioned step S2.1.1, the feature extraction stage is set as three feature extraction modules as required, and the feature extraction modules are connected by a downsampling module. Wherein the downsampling module consists of a 3×3 convolutional layer with a step length of 2 so as to reduce sizes of the feature maps and double the number of channels. The feature extraction stage consists of a plurality of large-kernel convolution modules, and each of which consists of a reparameterized dilated convolution block, a channel attention module, a spatial attention module, a feedforward neural network (FFN) layer, and a batch normalization (BN) layer to enhance the representational ability of the network. Each large-kernel convolution module adopts residual connections to facilitate gradient backpropagation and avoid the problem of gradient vanishing in deep network training.

Specifically, the introduction is shown as follows:

### \textcircled{1} Reparameterized Dilated Convolution Block

According to a principle of homogeneity, the reparameterized dilated convolution block can merge the batch normalization (BN) layer into the convolutional layer. For the jth channel for outputting the feature maps, operations of convolution and BN are written by an equation as follows (it is assumed that biases of convolution kernels are all 0):

$${O}_{j} = ( {( I * F )}_{j} - {u}_{j} ) \cdot \frac{{γ}_{j}}{{σ}_{j}} + {β}_{j} \qquad ( 3 )$$

wherein subscripts of all the symbols represent the j^{th} channel; I and F are input and convolutional layers; μⱼ and σⱼ are respectively a mean value and a standard deviation of the j^{th} channel of a feature map I*F; and rⱼ and βⱼ are a standard deviation and a mean value that are obtained by learning on the BN layer. In conjunction with equation (3) and the homogeneity, the j^{th} convolution kernel F^{j} of the convolutional layer F can be reparameterized as follows:

$${F}^{j} ← \frac{{γ}_{j}}{{σ}_{j}} {F}_{j} \qquad ( 4 )$$

and the bias corresponding to the convolution kernel F^{j} is reparameterized as:

$${b}^{j} ← - \frac{{μ}_{j} {γ}_{j}}{{σ}_{j}} + {β}_{j} \qquad ( 5 )$$

The large-sized convolution kernel used in the present disclosure takes a non-dilated small kernel and a plurality of dilated small kernels as parallel branches, both of which are designed as depthwise separable convolution, and output results thereof are superimposed. Its hyperparameters include a size of the large-sized convolution kernel K, a size of a parallel convolutional layer k, and a dilation rater.

### \textcircled{2} Channel Attention Module

In the channel attention module, firstly, spatial information of the feature maps are integrated through average pooling and maximum pooling operations to form two different spatial context descriptors:

$${F}_{avg}^{c} {F}_{max}^{c}$$

which respectively correspond to features obtained after the average pooling and maximum pooling operations. Then, these two descriptors are inputted into a shared neural network which is used to generate a channel attention map M_{c}∈R^{C×1×1}. This neural network is a multi-layer perceptron (MLP) including a single hidden layer. In order to optimize the usage of the parameters, an activation dimension of the hidden layer is set as M_{c}∈R^{c/r×1×1}, wherein r represents a reduction rate. Finally, output feature vectors of the two spatial context descriptors are fused through a bitwise addition operation. Channel attention can be represented by equation (6):

$$\begin{matrix}{M}_{c} ( F ) = σ ( MLP ( AvgPool ( F ) ) + MLP ( MaxPool ( F ) ) ) \\ = σ ( {W}_{1} ( {W}_{0} ( {F}_{avg}^{c} ) ) + ( {W}_{1} ( {W}_{0} ( {F}_{max}^{c} ) )\end{matrix} \qquad ( 6 )$$

wherein σ is a sigmoid function, and W₁ and W₀ are weights of the MLP, which are shared by an average pooling feature and a maximum pooling feature as two inputs.

### \textcircled{3} Spatial Attention Module

The spatial attention module uses overlapping circular pooling instead of a traditional pooling structure. Due to circular pooling area, a pooling region cannot fully cover a pooling window. Therefore, when maximum or average pooling is calculated, element values are weighted according to a proportion of coverage area to element area. Improved spatial attention can be represented by equation (7):

$$\begin{matrix}{M}_{s} ( F ) = σ ( {f}^{7 \times 7} ( [ {Cir}_{avgPool ( F )} ; {Cir}_{MaxPool ( F )} ] ) ) \\ = σ ( {f}^{7 \times 7} ( [ {F}_{avg}^{s} ; {F}_{max}^{s} ] ) )\end{matrix} \qquad ( 7 )$$

wherein σ is a sigmoid function, f^{7×7} represents a convolution operation of a convolution kernel with a size of 7×7, Cir_{AvgPool(•)} and Cir_{MaxPool(•)} respectively represent circular average pooling and circular maximum pooling operations, and [;] represents a Concat operation.

Further, in the above-mentioned step S2.1.2, each point P in the upsampled feature map corresponds to half of its original position in an original image, and then, four top left, top right, bottom left and bottom right feature vectors {Q₁₁, Q₁₂, Q₂₁, Q₂₂} closest in position in the original image are found. Thus, a feature vector value of point P is expressed as:

$$P = \frac{{y}_{p} - {y}_{2}}{{y}_{1} - {y}_{2}} {R}_{1} + \frac{{y}_{1} - {y}_{p}}{{y}_{1} - {y}_{2}} {R}_{2} wherein \qquad ( 8 )$$

$$\{ \begin{matrix}{R}_{1} = \frac{{x}_{p} - {x}_{2}}{{x}_{1} - {x}_{2}} {Q}_{11} + \frac{{x}_{1} - {x}_{p}}{{x}_{1} - {x}_{2}} {Q}_{12} \\ {R}_{2} = \frac{{x}_{p} - {x}_{2}}{{x}_{1} - {x}_{2}} {Q}_{21} + \frac{{x}_{1} - {x}_{p}}{{x}_{1} - {x}_{2}} {Q}_{22}\end{matrix} \qquad ( 9 )$$

in the equation, x₁ and x₂ respectively represent horizontal coordinates of Q₁₁ and Q₁₂, y₁ and y₂ respectively represent vertical coordinates of Q₁₁ and Q₂₁, and xₚ and yₚ respectively represent horizontal and vertical coordinates of point P.

The upsampled feature map is added to the corresponding horizontally-connected feature map so that different levels of feature information are integrated. In order to eliminate an aliasing effect that may be introduced by upsampling, the network further processes the fused feature map through a 3×3 convolutional layer. This process is repeated until the size of the feature map is restored to an original input size.

Further, in the above-mentioned step S2.1.3, at the feature fusion stage, the network integrates the upsampled feature map with the downsampled feature map with the same scale.

This process is completed by direct addition so that feature information from different levels is fused. In order to ensure the consistency of the number of channels in the fusion process, the network adjusts the number of the channels through the 1×1 convolution layer, so that requirements of subsequent processing are met.

Further, the above-mentioned step S2.2 that based on the ⅛-scale feature map, processing is performed by using a coarse-grained matching model to obtain a rough matching region includes the following steps:

S2.2.1, dimensional transformation is performed on coarse-level features of two images at ⅛ scale to obtain a score matrix S.

After multi-level features are extracted by the feature pyramid network, the coarse-level features of the two images at ⅛ scale are represented by FA and FB, and fine-level features of the two images at ½ scale are represented by \tilde{F}^{A} and \tilde{F}^{B}.

Dimensions of the features \tilde{F}^{A} and \tilde{F}^{B} are (C,w/8,h/8), C is the number of the channels, and w and h are a width and a height of the original image. For facilitating calculation, firstly, the last two dimensions of the features are merged into one dimension and are transformed into vector sequences

$${\hat{F}}_{tr}^{A} and {\hat{F}}_{tr}^{B}$$

with a dimension of Cand a length of w×h/64. The correlation is represented by a vector inner product to obtain the score matrix S, and a specific equation is shown as follows:

$$S ( i , j ) = \frac{1}{τ} \cdot 〈 {\tilde{F}}_{tr}^{A} ( i ) , {\tilde{F}}_{tr}^{B} ( j ) 〉 \qquad ( 10 )$$

wherein

$${\tilde{F}}_{tr}^{A} and {\tilde{F}}_{tr}^{B}$$

respectively represent the transformed vector sequences, [symbol] represents the inner product, and τ is a hyperparameter for adjusting a numerical range of the score matrix.

S2.2.2, a softmax operator is respectively applied to two dimensions of the score matrix, and the score matrix is transformed into a probability to obtain a confidence matrix P_{c} represented by the following equation:

$${P}_{c} ( i , j ) = {softmax ( S ( i , \cdot ) )}_{j} \cdot {softmax ( S ( \cdot , j ) )}_{i} \qquad ( 11 )$$

S2.2.3, based on the confidence matrix P_{c}, matching with confidence being lower than a threshold θ_{c} is filtered out, and a mutual nearest neighbor criterion is performed on remaining matching to obtain the rough matching region.

The mutual nearest neighbor criterion is executed, that is, feature

$${\tilde{F}}_{tr}^{A} ( i )$$

with the highest matching rate in Fig. A is feature

$${\tilde{F}}_{tr}^{B} ( j )$$

in Fig. B, conversely feature

$${\tilde{F}}_{tr}^{B} ( j )$$

with the highest matching rate in Fig. B is also feature

$${\tilde{F}}_{tr}^{A} ( i )$$

in Fig. A and thus,

$${\tilde{F}}_{tr}^{A} ( i ) and {\tilde{F}}_{tr}^{B} ( j )$$

are regarded as a pair of matching only meeting the mutual nearest neighbor criterion, are marked as (\tilde{ι}, \tilde{J}) represented by equation (12). This method improves the accuracy and robustness of matching by ensuring that the matching is bidirectional.

$${M}_{c} = \{ ( \tilde{i} , \tilde{j} ) \vert ∀ ( \tilde{i} , \tilde{j} ) ∈ MNN ( {P}_{c} ) , {P}_{c} ( \tilde{i} , \tilde{j} ) \geq {θ}_{c} \} \qquad ( 12 )$$

Further, the above-mentioned step S2.3 that the based on the ½-scale feature map and the rough matching region, processing is performed by using a fine-grained matching model to obtain accurate positions of matched feature points includes the following steps:
S2.3.1, rough matching (\tilde{ι}, \tilde{J}) is positioned in fine-level feature maps \hat{F}^{A} and \hat{F}^{B} to obtain a local neighborhood (\hat{ι}, Ĵ);
S2.3.2, two sets of local features

$${\hat{F}}_{c}^{A} and {\hat{F}}_{c}^{B}$$

with a size of w×w are cropped, and Feature-Transformer transformation is performed on the local neighborhood (\hat{ι}, Ĵ) to obtain two local feature maps

$${\hat{F}}_{tr}^{A} and {\hat{F}}_{tr}^{B} ;$$

S2.3.3, a heat map of a matching probability of the two feature maps is obtained by using similarity calculation and a softmax function; and
S2.3.4, the accurate positions of the matched points are calculated from the heat map by using a DSNT algorithm.

Further, the above-mentioned step S2.3.2 specifically includes the following steps:

\textcircled{1} before feature transformation, firstly, position encoding is performed on the two sets of local features

$${\hat{F}}_{c}^{A} and {\hat{F}}_{c}^{B}$$

with the size of w×w.

An attention mechanism of a Transformer can extract context associated information of the features, but its structure is insensitive to a sequence position order, and when applied to images, it cannot capture spatial position information. Therefore, before feature transformation is performed on the local features, the position encoding is required. In this embodiment, a 2D extended version of absolute sine and cosine position encoding in DETR is adopted, and a position encoding vector is given as the following equation:

$${𝒫ε}_{x , y}^{i} = {f ( x , y )}^{i} = \{ \begin{matrix}sin ( {ω}_{k} \cdot x ) , & i = 4 k \\ cos ( {ω}_{k} \cdot x ) , & i = 4 k + 1 \\ sin ( {ω}_{k} \cdot y ) , & i = 4 k + 2 \\ cos ( {ω}_{k} \cdot y ) , & i = 4 k + 3\end{matrix} \qquad ( 13 )$$

wherein

$${ω}_{k} = \frac{1}{1000 {0}^{2 k / d}} ,$$

d is the number of channels needing to add position encoding features, i is an index of a feature channel, and

$${𝒫ε}_{x , y}^{i}$$

is the position encoding vector. In this way, position encoding provides unique position information for each element in a form of sine and cosine, thereby integrating the position information into an input of the model. This is crucial for generating accurate matching in textureless regions.

\textcircled{2} A Feature Transformer module performs feature transformation on the feature maps fused with the position information.

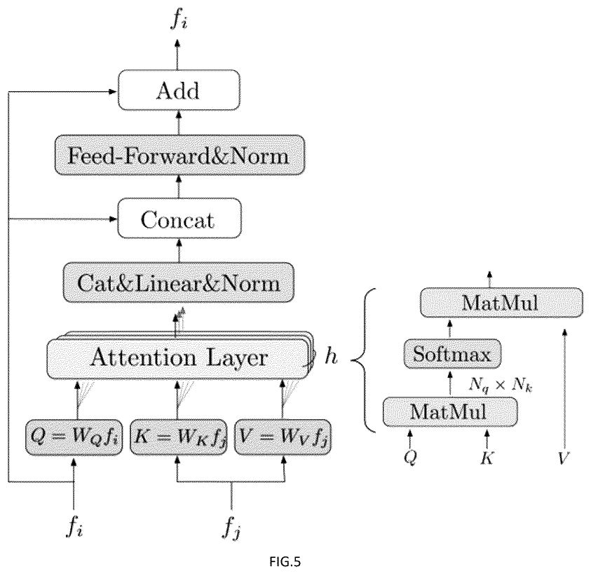

An original Transformer consists of an encoder and a decoder, the Feature Transformer module used in this embodiment consists of a plurality of cascaded encoders, and a structure of each encoder is shown in FIG. 5. Firstly, the encoder respectively multiplies a position encoding vector sequence of an input with weight matrices W_{q}, Wₖ and Wᵥ to obtain Q (Query), K (Key) and V (Value) matrices; secondly, the Q, K and V matrices are inputted to a multi-head attention mechanism, contextual information is extracted, and then, outputs of a plurality of heads are normalized after passing through a linear layer; thirdly, an output of a normalization layer is concatenated with the input of the encoder, and then, information fusion is performed through a feedforward neural network; and finally, an original input is added to an output of the feedforward neural network to obtain a final result.

According to different input features, attention layers are divided into two types: self-attention layers and cross-attention layers. Input features fᵢ and fⱼ processed by the self-attention layers are from the same feature map that is

$${\hat{F}}_{c}^{A} and {\hat{F}}_{c}^{B} .$$

Input features processed by the cross-attention layers are from two different feature maps that are

$${\hat{F}}_{c}^{A} and {\hat{F}}_{c}^{B} .$$

The self-attention layers and the cross-attention layers are interlaced and connected to form a deep network structure.

Further, in the above-mentioned step S2.3.3, after the Feature Transformer transformation, the two local feature maps

$${\hat{F}}_{tr}^{A} and {\hat{F}}_{tr}^{B}$$

are obtained, and they are respectively set with \hat{ι} and Ĵ as centers. The similarity s between a center vector

$${\hat{F}}_{tr}^{A} ( \hat{i} )$$

of the feature map

$${\hat{F}}_{tr}^{A}$$

and all vectors in the feature map

$${\hat{F}}_{tr}^{B}$$

is calculated by using equation (14).

$$s ( j ) = 〈 {\hat{F}}_{tr}^{{}_{A}} ( \hat{i} ) , {\hat{F}}_{tr}^{{}_{B}} ( j ) 〉 \qquad ( 14 )$$

The similarity s is transformed into a probability distribution through the softmax function and is represented in a form of a 2D image to obtain a heat map H(j) representing a matching probability.

$$H ( j ) = softmax ( \frac{s}{\sqrt{C}} ) \qquad ( 15 )$$

wherein C is the number of channels of a feature map.

Further, in the above-mentioned step S2.3.4, sub-pixel-level coordinates of each matched point in an image B are calculated from a heat map H by using a DSNT (Differential Spatial to Numerical Transform) algorithm. For DSNT, the heat map is regarded as the probability distribution firstly, and then its spatial expectation is calculated to obtain a position Ĵ′ of sub-pixel accuracy:

$${\hat{j}}^{′} = {\sum }_{j} j \cdot H ( j ) \qquad ( 16 )$$

and meanwhile, the variance estimation matching uncertainty of the coordinates is calculated for subsequent calculation:

$${σ}^{2} ( \hat{i} ) = {\sum }_{j} {j}^{2} H ( j ) ) - {\hat{j}}^{′2} \qquad ( 17 )$$

Further, when model training is performed on the deep-learning-based feature point matching network model constructed in step S2, its loss function needs to be determined firstly.

In the present disclosure, the final loss consists of coarse-level loss and fine-level loss:

$$ℒ = {ℒ}_{c} + {ℒ}_{f} \qquad ( 18 )$$

Coarse-level matching is applied to features accounting for ⅛ of the size of the original image, each feature represents a pixel grid in the original image, and therefore, there may be one-to-many matching. This makes it difficult to determine a true value of the coarse-level matching. Therefore, the nearest neighbor between center positions of ⅛ grids of input images is used as an approximate true value. Specifically, a center position of a ⅛ grid in a left image is captured and is projected onto the same scale as a depth map, and its depth is indexed. Its 3D coordinates in a camera coordinate system are calculated according to its depth value and the intrinsic parameters of the camera; and it is transformed to a camera coordinate system of a second image according to a camera pose, and finally, it is re-projected onto a pixel coordinate system. Wherein it is necessary to check that the transformed points are within an image boundary and a depth consistency error is less than 0.2, and the nearest neighbor of a point that meets the conditions is taken as a matching candidate. The same process is repeated from the right image to the left image. The final true value is also filtered from the two sets of obtained nearest neighbor matching according to the mutual nearest neighbor criterion. True coarse-level matching is marked as

$${M}_{c}^{gt} ,$$

and focal loss is calculated.

For a positive sample, namely a position where

$${M}_{c}^{gt} ( i , j ) = 1 ,$$

its loss is represented as:

$${ℒ}_{p o s} = - α {\sum }_{{M}_{c}^{g t} ( i , j ) = 1} {( 1 - P ( i , j ) )}^{γ} log ( P ( i , j ) ) \qquad ( 19 )$$

For a negative sample, namely a position where

$${M}_{c}^{gt} ( i , j ) = 0 ,$$

its loss is represented as:

$${ℒ}_{n e g} = - ( 1 - α ) {\sum }_{{M}_{c}^{g t} ( i , j ) = 0} {P ( i , j )}^{γ} log ( 1 - P ( i , j ) ) \qquad ( 20 )$$

wherein α is a coefficient for balancing weights of the positive and negative samples, and γ is an adjustment factor for reducing weights of easily-classified samples. The final loss is represented as:

$${ℒ}_{c} = \frac{{ℒ}_{p o s}}{\vert {M}_{p o s} \vert} + \frac{{ℒ}_{n e g}}{\vert {M}_{n e g} \vert} \qquad ( 21 )$$

Herein, |Mₚₒₛ| and |M_{neg}| are respectively the number of positive samples and the number of negative samples, and are used for standardizing the loss. In this way, the loss of each part is averaged by the numbers of their respective samples, which is beneficial to balancing influences of the positive and negative samples, especially when their numbers are imbalanced.

In fine-level loss, for each query point \hat{ι}, a total variance of the heat map is calculated to represent its uncertainty. The 2-norm of an error is weighted by using an inverse of the variance, which aims at optimizing positions with lower uncertainty and calculating an average value to obtain a final weighted loss function:

$${ℒ}_{f} = \frac{1}{\vert {M}_{f} \vert} {\sum }_{( \hat{i} , {\hat{j}}^{′} ) ∈ {M}_{f}} \frac{1}{{σ}^{2} ( \hat{i} )} {‖ {\hat{j}}^{′} - {\hat{j}}_{gt}^{′} ‖}_{2} \qquad ( 22 )$$

Wherein Ĵ′ is a predicted point corresponding to the query point \hat{ι}, and

$${\hat{J}}_{gt}^{′}$$

is a point obtained after \hat{ι} is re-projected according to the camera pose. σ²(\hat{ι}) is the total variance of the heat map. M_{f} represents a set of fine-grained matching points.

Further, in the above-mentioned step S3, the present disclosure is a detector-free matching method, and when positions of feature points are refined, they are obtained from an expected result calculated according to equation (14). Therefore, it cannot be ensured that consistent matching points are generated between images, which results in feature trajectory fragmentization. Therefore, it is necessary to aggregate and redistribute the feature points before reconstruction.

Specifically, it is assumed that there is a set {I₁, I₂, . . . I_{N}} of images, after feature point extraction and matching, the matched points of each image and all other images are obtained. For any two images Iₙ and Iₘ, a matching result can be represented as a series of matching pairs Mₙₘ={(kₙᵢ, kₘⱼ)}, wherein kₙᵢ is the ith feature point in image Iₙ, and kₘⱼ is the jth feature point in image Iₘ. Each feature point can be further represented as 2D coordinates (xₙᵢ, yₙᵢ). For each image Iₙ, an empty aggregated feature point set Kₙ={ } is initialized. The feature points are quantized: a picture is divided into a plurality of units according to a size of Δx×Δy, each unit is uniquely identified by an index pair (m, n), wherein m and n respectively represent the indexes of a grid in x and y directions. According to the positions of the feature points, the feature points are distributed to each unit, and a quantization function q is represented as:

$$q ( {k}_{n i} ) = ( ⌊ \frac{{x}_{n i}}{Δ x} ⌋ , ⌊ \frac{{y}_{n i}}{Δ y} ⌋ ) \qquad ( 23 )$$

For the quantized feature points q(kₙᵢ), if there are no identical quantization positions in the aggregated feature point set Kₙ, q(kₙᵢ) is added to Kₙ. If new feature points kₙᵢ are distributed to quantification positions of existing feature points

$${k}_{ni}^{′} ,$$

the position of

$${k}_{ni}^{′}$$

is finely adjusted according to their scores (matching probabilities). By weighted averaging, it is implemented as:

$${k}_{ni}^{′} = \frac{{w}_{n i} {k}_{n i} + {w}_{ni}^{′} {k}_{ni}^{′}}{{w}_{n i} + {w}_{ni}^{′}} \qquad ( 24 )$$

wherein wₙᵢ and

$${w}_{n i}^{′}$$

are respectively scores of kₙᵢ and

$${k}_{ni}^{′} .$$

The existing scores are updated by accumulating new matching scores:

$${w}_{ni}^{′} = {w}_{ni}^{′} + {w}_{n i} \qquad ( 25 )$$

After matching of all image pairs is processed, an optimized aggregated feature point set Kₙ of each image is obtained.

Feature point matching results are redistributed based on the aggregated feature point set Kₙ.

In this embodiment, a position

$$( {k}_{ai}^{′} , {k}_{bj}^{′} )$$

of each matching pair (kₐᵢ, k_{bj})∈M_{ab} in the aggregated feature point set is found by using nearest neighbor search (NN search), and the matching pair is marked as a new matching pair in the aggregated feature point set.

By means of the two steps of aggregation and redistribution, the feature points are screened and optimized, the possibility of mismatching is reduced, and the robustness of the positions of the feature points is enhanced. Meanwhile, in this process, consistent matching information is extracted from a plurality of images, which increases trajectory lengths of feature points, so that subsequent reconstruction is more stable.

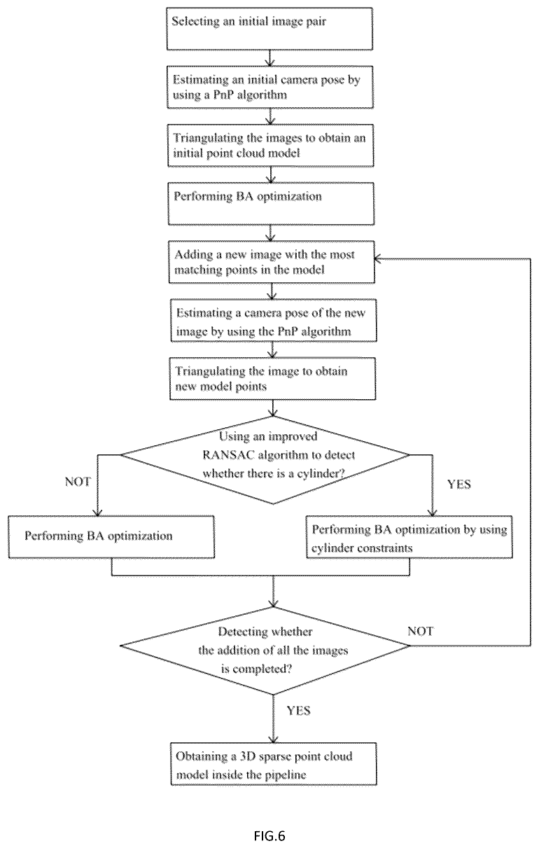

Further, in the above-mentioned step S4, as shown in FIG. 6, 3D sparse reconstruction is performed by using an improved incremental reconstruction algorithm to obtain internal structural information of the to-be-detected non-metallic pipeline, which includes the following steps:
S4.1, two pictures are selected, an initial camera pose is obtained by using a PnP algorithm, the images are triangulated according to the initial camera pose to obtain 3D points as an initial point cloud model, and local BA optimization is used;
S4.2, an image with the most matched points in the point cloud model is selected, a camera pose of a new image is obtained by using the PnP algorithm, and the new image is triangulated according to the camera pose to obtain new 3D points;
S4.3, an improved RANSAC algorithm is used to detect whether the point cloud model is cylindrical; and if the point cloud model is detected to be cylindrical, cylinder constraints are added to local RA to optimize positions of the 3D points; and
S4.4, steps S4.2 to S4.3 are repeated until the feature points of all the images are added to the point cloud model.

Wherein the PnP algorithm and an image triangulation algorithm adopt technologies well known by the skilled in the art so as not to be repeated in the present disclosure.

Further, in the above-mentioned step S4.3, after the new 3D points are added to the point cloud model, a parameter C of the cylindrical model is estimated by using the improved RANSAC algorithm. In order to estimate the model more robustly, an angle difference of a normal direction of a point and an axis direction of a cylinder is weighted when a distance from a point cloud to the model is estimated.

Firstly, for each point qᵢ in the point cloud, K adjacent points nearest to the point are searched to obtain a point cloud set P={p₁, p₂, . . . , pₙ} in the neighborhood, wherein each pᵢ∈ [symbol] . Thus, a neighborhood center p̅(x̅, y̅, z̅):

$$\overline{p} = \frac{1}{n} {\sum }_{i = 1}^{n} {p}_{i} \qquad ( 26 )$$

P is decentralized, and the neighborhood center is subtracted from each element in P:

$${p}_{i}^{′} = {p}_{i} - \overline{p} , ( i = 1 , ⋯ , n ) \qquad ( 27 )$$

A covariance matrix C is calculated:

$$C = \frac{1}{n} {\sum }_{i = 1}^{n} {{p}_{i}^{′} ( {p}_{i}^{′} )}^{T} \qquad ( 28 )$$

A feature value λᵢ and a feature vector vᵢ (i=1,2,3) of the covariance matrix are calculated:

$$C {v}_{i} = {λ}_{i} {v}_{i} \qquad ( 29 )$$

Sorting is sequentially performed according to the feature value, and it is assumed that λ₁≥λ₂≥λ₃, a feature vector corresponding to λ₁ is a normal vector of point qᵢ. In an ideal situation, a distance from a point on a cylindrical surface to the axis of the cylinder is a radius r, and the normal vector of the point is perpendicular to the axis of the cylinder. Therefore, the calculation of the distance from the point to the estimated cylindrical model by using the improved RANSAC can include these two terms:

$${D}_{total} ( {p}_{i} , C ) = \vert r - D ( {p}_{i} , C ) \vert + W \vert {n}_{i} \cdot d \vert \qquad ( 30 )$$

wherein r is the radius of the cylinder, D(pᵢ, C) is a distance from the point pᵢ to the axis of the cylinder, nᵢ is the normal vector of the point, dis an axis direction vector of the cylinder, and W is a weight coefficient for balancing the distance from the point to the axis of the cylinder and the perpendicularity of a normal of the point and a normal of the axis. In practical applications, cylinder estimation cannot be performed at the beginning of reconstruction, and is performed after a certain number of 3D points are reconstructed, which is due to a fact that a small number of sample points may lead to a significant estimation bias. Once the cylinder is detected, the cylinder constraints can be added to the bundle adjustment:

$$E ( X , P , K , C ) = {E}_{rep} ( X , P , K ) + α {E}_{cyl} ( X , C ) \qquad ( 31 )$$

wherein the first term Eᵣₑₚ(X, P, K) is a re-projection error term, the second term E_{cyl}(X,C) is a cylinder constraint term, and X, P, K, C respectively represent a 3D point set, an image pose, an intrinsic parameter of the camera, and a detected cylinder parameter. α is a weight for controlling two error terms. A distance from a 3D point to a surface of the cylinder is calculated by using the cylinder constraint term:

$${E}_{cyl} ( X , C ) = {\sum }_{j = 1}^{M} {‖ d ( {X}_{j} , C ) ‖}^{2} \qquad ( 32 )$$

Wherein d(Xⱼ, C) is a distance function from the 3D point Xⱼ to the cylindrical surface.

FIG. 7 is a flow diagram of the used improved RANSAC algorithm. Firstly, a minimum required dataset Sₘᵢₙ is selected to estimate model parameters. It is assumed that the current optimal solution is found in a certain iteration. In order to further improve the accuracy of the solution, a local optimization strategy is introduced on this basis, that is, the number k of local iterations is set, and in this process, an additional sample point p is selected from an inlier set I and is added to Sₘᵢₙ to form an extended dataset Sₑₓₚ. The model parameters are recalculated by using Sₑₓₚ, and the number of inliers of the new model is evaluated. If the number of the inliers of this extended model exceeds the number of inliers of the current optimal solution, the new model is accepted as the optimal solution, and the current optimal state is updated; and if not, this sample point is rejected, and another point is selected from I for a try. This process is repeated within k local iterations in an attempt to find a more accurate model solution by adding sample points.

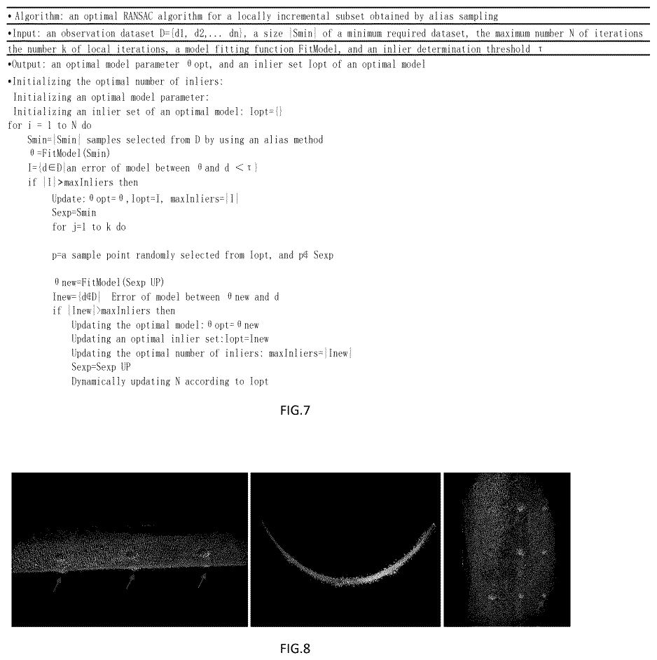

After the above-mentioned steps are performed, the present disclosure finally obtains a 3D sparse point cloud image inside the pipeline, which can be used for subsequent dense reconstruction and texture mapping. FIGS. 8, 9, and 10 show 3D sparse reconstruction point cloud images of an inner wall of the pipeline obtained by using the method in the present disclosure. FIG. 8 is an effect diagram of cone point defect reconstruction, FIG. 9 is an effect diagram of groove defect reconstruction, and

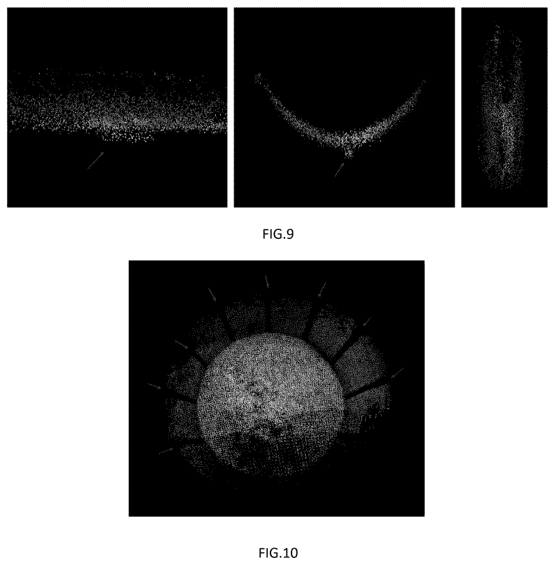

FIG. 10 is an effect diagram of strip defect reconstruction.

### Embodiment 2

The above-mentioned embodiment 1 provides a 3D sparse reconstruction method for a monocular image of a non-metallic pipeline for deep-sea mining. Correspondingly, this embodiment provides a 3D sparse reconstruction device for a monocular image of a non-metallic pipeline for deep-sea mining. The 3D sparse reconstruction method for a monocular image of a non-metallic pipeline for deep-sea mining in embodiment 1 can be implemented by using the device provided in this embodiment, and the device can be implemented through software, hardware, or a combination of the software and the hardware. For example, this device may include integrated or separate functional modules or functional units to perform the corresponding steps in each method in embodiment 1. Due to the fact that the device in this embodiment is basically similar to the method embodiment, the description process of this embodiment is relatively simple. Relevant details can be found in the partial explanation of embodiment 1. The embodiment of the device provided in this embodiment is only illustrative.

The 3D sparse reconstruction device for a monocular image of a non-metallic pipeline for deep-sea mining provided in this embodiment includes:
a data acquisition module configured to acquire internal pictures of a to-be-detected non-metallic pipeline by using a robot carrying a monocular camera to form a dataset;
a feature point matching module configured to perform feature point detection and matching on the dataset by using a deep-learning-based feature point matching network model;
an aggregation and redistribution module configured to aggregate and redistribute obtained feature points; and
a 3D coefficient reconstruction module configured to perform 3D sparse reconstruction by using an improved incremental reconstruction algorithm to obtain internal structural information of the to-be-detected non-metallic pipeline.

Finally, it should be noted that the above embodiments are only intended to illustrate the technical solutions of the present disclosure, rather than to limit the present disclosure. Although the present disclosure has been described in detail with reference to the above embodiments, it should be understood by those of ordinary skill in the art that modifications or equivalent substitutions can still be made to the specific embodiments of the present disclosure, and any modifications or equivalent substitutions that do not depart from the spirit and scope of the present disclosure should fall within the protective scope of the claims of the present disclosure.

1. A 3D sparse reconstruction method for a monocular image of a non-metallic pipeline for deep-sea mining, comprising the following steps:
acquiring internal pictures of a to-be-detected non-metallic pipeline by using a robot carrying a monocular camera to form a dataset;
performing feature point detection and matching on the dataset by using a deep-learning-based feature point matching network model;
aggregating and redistributing obtained feature points; and
based on the aggregated feature points, performing 3D sparse reconstruction by using an improved incremental reconstruction algorithm to obtain internal structural information of the to-be-detected non-metallic pipeline.

2. The 3D sparse reconstruction method for a monocular image of a non-metallic pipeline for deep-sea mining of claim 1, wherein the acquiring internal pictures of a to-be-detected non-metallic pipeline by using a robot carrying a monocular camera to form a dataset comprises:
determining a structure of the robot;
wherein the robot comprises a camera protective cover, a camera compartment, a plurality of odometer wheels, a substrate, and support wheels; a lower part of the substrate is fixedly connected with a bottom plate through a flange, and three support wheels playing a supporting role are disposed on a lower part of the bottom plate to ensure that a center line of the robot and a center line of the pipeline are located on the same line; an upper part of the substrate is connected with the camera compartment through another flange, and a spring is provided between the camera compartment and another flange; the camera protective cover is disposed on the top of the camera compartment to protect the monocular camera placed inside the camera compartment; the odometer wheels are spaced outside the camera compartment, and magnetic encoders are built in the odometer wheels to measure angles of rotation of the odometer wheels; and a circuit system is placed inside the substrate to receive pulse signals sent by the magnetic encoders, calculate displacement data of the robot according to parameters of the odometer wheels, and control the monocular camera to take the internal pictures of the pipeline according to the displacement data;
carrying the monocular camera by the robot, and calibrating the monocular camera by using a Zhang's calibration method to acquire intrinsic parameters of the camera; and
placing the robot into the to-be-detected non-metallic pipeline, controlling the robot to move forwards at a preset speed, and meanwhile, taking the internal pictures of the to-be-detected non-metallic pipeline by using the monocular camera to form the dataset.

3. The 3D sparse reconstruction method for a monocular image of a non-metallic pipeline for deep-sea mining of claim 2, wherein the carrying the monocular camera by the robot, and calibrating the monocular camera by using a Zhang's calibration method to acquire camera intrinsic parameters comprises:
fixing a preset black-and-white checkerboard calibration paper on a desktop;
capturing a plurality of images of the calibration paper at different angles and positions by using the monocular camera carried by the robot, and ensuring that a checkerboard pattern in each image is within a field of view, wherein during capturing, a posture and position of the monocular camera should be sufficiently varied to cover different viewing angles; and
based on image information obtained from the calibration paper, calculating the intrinsic parameters of the monocular camera by using the Zhang's calibration method.

4. The 3D sparse reconstruction method for a monocular image of a non-metallic pipeline for deep-sea mining of claim 2, wherein the placing the robot into the to-be-detected non-metallic pipeline, controlling the robot to move forwards at a preset speed, and meanwhile, taking the internal pictures of the to-be-detected non-metallic pipeline by using the monocular camera to form the dataset comprises:
placing the robot carrying the monocular camera at an inlet of the to-be-detected non-metallic pipeline, and clearing data of the odometer wheels;
controlling the robot to move forwards in the to-be-detected non-metallic pipeline, meanwhile, acquiring displacement information of the robot in the to-be-detected non-metallic pipeline by the circuit system inside the substrate through the odometer wheels, controlling the monocular camera to take the internal pictures of the to-be-detected non-metallic pipeline according to the displacement information, and saving the pictures; and
stopping the robot after reaching an endpoint, reading all the pictures by using an upper computer, and creating the dataset of the internal pictures of the to-be-detected non-metallic pipeline in a picture taking order.

5. The 3D sparse reconstruction method for a monocular image of a non-metallic pipeline for deep-sea mining of claim 1, wherein the performing feature point detection and matching on the dataset by using a deep-learning-based feature point matching network model comprises:
performing different-scale feature extraction on input pictures by using a feature pyramid network to obtain a ½-scale feature map and a ⅛-scale feature map;
based on the ⅛-scale feature map, performing processing by using a coarse-grained matching model to obtain a rough matching region; and
based on the ½-scale feature map and the rough matching region, performing processing by using a fine-grained matching model to obtain accurate positions of matched feature points.

6. The 3D sparse reconstruction method for a monocular image of a non-metallic pipeline for deep-sea mining of claim 5, wherein the performing different-scale feature extraction on input pictures by using a feature pyramid network to obtain a ½-scale feature map and a ⅛-scale feature map comprises:
performing feature extraction on two input images to sequentially obtain ½-scale and ¼-scale downsampled feature maps, and outputting the ⅛-scale feature map;
upsampling the different-scale downsampled feature maps obtained at a feature extraction stage by using bilinear interpolation to sequentially obtain ¼-scale and ½-scale upsampled feature maps; and
fusing the ½-scale upsampled feature map with the ½-scale downsampled feature map to obtain the final ½-scale feature map.

7. The 3D sparse reconstruction method for a monocular image of a non-metallic pipeline for deep-sea mining of claim 5, wherein the based on the ⅛-scale feature map, performing processing by using a coarse-grained matching model to obtain a rough matching region comprises:
performing dimensional transformation on coarse-level features of two images at ⅛ scale to obtain a score matrix S;
respectively applying a softmax operator to two dimensions of the score matrix, and transforming the score matrix into a probability to obtain a confidence matrix P_{c}; and
based on the confidence matrix P_{c}, filtering out matching with confidence being lower than a threshold θ_{c}, and performing a mutual nearest neighbor criterion on remaining matching to obtain the rough matching region (\tilde{ι}, \tilde{J}).

8. The 3D sparse reconstruction method for a monocular image of a non-metallic pipeline for deep-sea mining of claim 5, wherein the based on the ½-scale feature map and the rough matching region, performing processing by using a fine-grained matching model to obtain accurate positions of matched feature points comprises:
positioning rough matching (\tilde{ι}, \tilde{J}) in fine-level feature maps \hat{F}^{A} and \hat{F}^{B} to obtain a local neighborhood (\hat{ι},Ĵ);
cropping two sets of local features
$${\hat{F}}_{c}^{A} and {\hat{F}}_{c}^{B}$$
with a size of w×w, and performing Feature-Transformer transformation on the local neighborhood (\hat{ι}, Ĵ) to obtain two local feature maps
$${\hat{F}}_{tr}^{A} and {\hat{F}}_{tr}^{B} ;$$
obtaining a heat map of a matching probability of the two feature maps by using similarity calculation and a softmax function; and
calculating the accurate positions of the matched points from the heat map by using a DSNT (Differentiable Spatial to Numerical Transform) algorithm.

9. The 3D sparse reconstruction method for a monocular image of a non-metallic pipeline for deep-sea mining of claim 1, wherein the performing 3D sparse reconstruction by using an improved incremental reconstruction algorithm to obtain internal structural information of the to-be-detected non-metallic pipeline comprises:
\textcircled{1} selecting two pictures, obtaining an initial camera pose by using a PnP algorithm, triangulating the images according to the initial camera pose to obtain 3D points as an initial point cloud model, and using local BA (Bundle Adjustment) optimization;
\textcircled{2} selecting an image with the most matched points in the point cloud model, obtaining a camera pose of a new image by using the PnP algorithm, and triangulating the new image according to the camera pose to obtain new 3D points;
\textcircled{3} using an improved RANSAC (Random Sample Consensus) algorithm to detect whether the point cloud model is cylindrical, and if the point cloud model is detected to be cylindrical, adding cylinder constraints to local RA (Reasonable Adjustment) to optimize positions of the 3D points; and
\textcircled{4} repeating steps 2 to 3 until the feature points of all the images are added to the point cloud model.

10. A 3D sparse reconstruction device for a monocular image of a non-metallic pipeline for deep-sea mining, comprising:
a data acquisition module configured to acquire internal pictures of a to-be-detected non-metallic pipeline by using a robot carrying a monocular camera to form a dataset;
a feature point matching module configured to perform feature point detection and matching on the dataset by using a deep-learning-based feature point matching network model;
an aggregation and redistribution module configured to aggregate and redistribute obtained feature points; and
a 3D coefficient reconstruction module configured to perform 3D sparse reconstruction by using an improved incremental reconstruction algorithm to obtain internal structural information of the to-be-detected non-metallic pipeline.
